(19) United States
(12) Patent Application Publication
(10) Pub. No.: US 2008/0113646 A1
(43) Pub. Date: May 15, 2008

(54) METHOD AND SYSTEM FOR RESTRICTING MINUTE USAGE OF A MOBILE PHONE ADDRESS BOOK ENTRY

(76) Inventors: Michelle R. Cereceres, Austin, TX (US); Francisco Garcia, Manor, TX (US); David Nevarez, Austin, TX (US); Marcos A. Villarreal, Austin, TX (US)

Correspondence Address: DILLON & YUDELL LLP, 8911 N. CAPITAL OF TEXAS HWY.,, SUITE 2110, AUSTIN, TX, 78759, US

(21) Appl. No.: 11/558,203

(22) Filed: Nov. 9, 2006

(51) Int. Cl. H04M 15/00

(52) U.S. Cl. 455/405

(57) ABSTRACT

A method of enabling a mobile phone to manage the minute usage of a mobile phone subscriber. The mobile phone contains a database with multiple records for people and/or businesses known to the user. Within each record, the user may define a minute limit and specify an enforcement action that will be implemented if the minute limit for that record is exceeded during the billing period. The enforcement actions include displaying an informative message that the allotted minutes have been exceeded then allowing the call to continue, or suspending minute usage for the duration of the billing cycle for the record in question. When an incoming call is received or an outgoing call is requested, the sum of the minutes used of the record is compared to the pre-set minute limit of the record. If the minutes used exceed the pre-set minute limit, the pre-set enforcement action is implemented.

### BACKGROUND OF THE INVENTION

1. Technical Field

The present invention relates in general to the field of portable electronic devices and in particular to mobile phones. Still more particularly, the present invention relates to an improved method and system for managing the minute usage of a mobile phone subscriber.

2. Description of the Related Art

A mobile phone (also referred to as a cellular telephone or cell phone) is a portable electronic device capable of enabling a user to communicate over long distances via wireless communication channels. Conventional mobile phones utilize a network of base stations. This network may be communicatively connected to a public switched telephone network (PSTN) to enable communication to landline telephone subscribers.

Multiple wireless service providers utilize the PSTN to enable mobile phone users to communicate. Each wireless service provider typically offers users one or more service plans. For a given mobile phone service plan, a user is granted a limited amount of minutes that he/she can use each month before being charged an additional fee. Since it is often hard for a subscriber to manage and track their minute usage, mobile phone users often exceed their allocated amount of minutes, thereby resulting in increased subscription fees.

Wireless service providers currently offer various cost saving features, such as free minutes when calling another subscriber of the same service provider and free (non-chargeable) minutes during off-peak hours. However, a mobile phone user typically makes calls to subscribers of other service providers and/or makes calls during peak hours. Other conventional service plans types, such as pay as you go plans, prevent subscribers from paying additional fees, but do not enable subscribers to efficiently account for how minutes are utilized. Consequently, an improved method and system for enabling a mobile phone to manage the minute usage of a mobile phone subscriber is needed.

### SUMMARY OF THE INVENTION

Disclosed is a method, system, and computer program product for enabling a mobile phone to manage the minute usage of a mobile phone subscriber. The system memory of the mobile phone contains a database that includes multiple records for people and/or businesses known to the user. Within each record, the user may define a maximum number of minutes that may be spent talking to the phone numbers associated with that record during each billing cycle. A user can also specify an enforcement action that will be implemented if the allotted amount of minutes is exceeded. The enforcement actions include displaying an informative message that the total allotted minutes have been exceeded then allowing the call to continue, or blocking the call by suspending the minute usage for the remaining duration of the billing cycle for the record in question. A user may thus efficiently manage and track their minute usage per called contact in order to minimize potential expenses that would otherwise be incurred if the user exceeded the minutes allocated by their mobile phone service plan.

The above as well as additional objectives, features, and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 depicts a high level block diagram of a mobile phone, according to an embodiment of the present invention;

FIG. 2 illustrates exemplary data within an address book of a mobile phone, according to an embodiment of the present invention;

FIG. 3 is a high level logical flowchart of an exemplary method of enabling a mobile phone to manage incoming calls in accordance with one embodiment of the invention; and

FIG. 4 is a high level logical flowchart of an exemplary method of enabling a mobile phone to manage outgoing calls in accordance with one embodiment of the invention.

### DETAILED DESCRIPTION OF AN ILLUSTRATIVE EMBODIMENT

The present invention provides a method, system, and computer program product for enabling a mobile phone to manage the minute usage of a mobile phone subscriber.

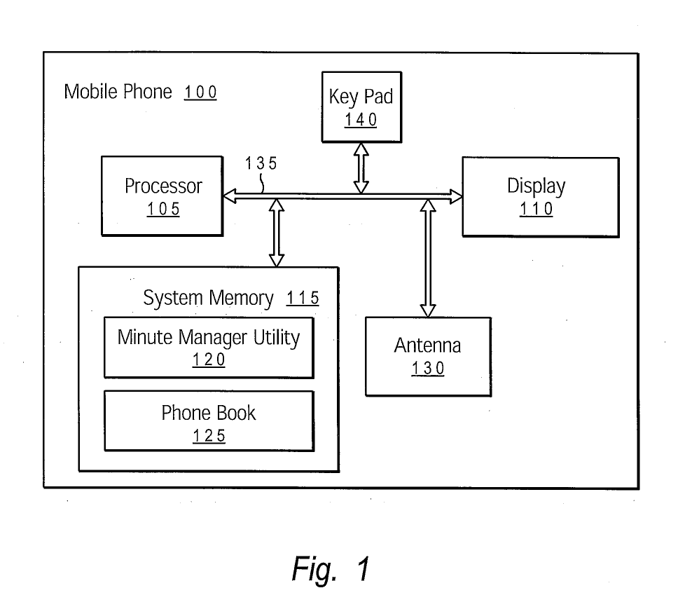

With reference now to FIG. 1, there is depicted a high level block diagram of a mobile phone, according to an embodiment of the present invention. Mobile phone 100 comprises processor 105, display 110, system memory 115, and key pad 140, which are communicatively connected via system bus 135. In one embodiment, processor 105 is a digital signal processor (DSP). Mobile phone 100 also includes antenna 130, which enables mobile phone 100 to transmit and receive data via a network of cellular base stations (not shown) controlled by a cellular telephone service provider. System memory 115 includes minute manager utility 120 and phone book 125.

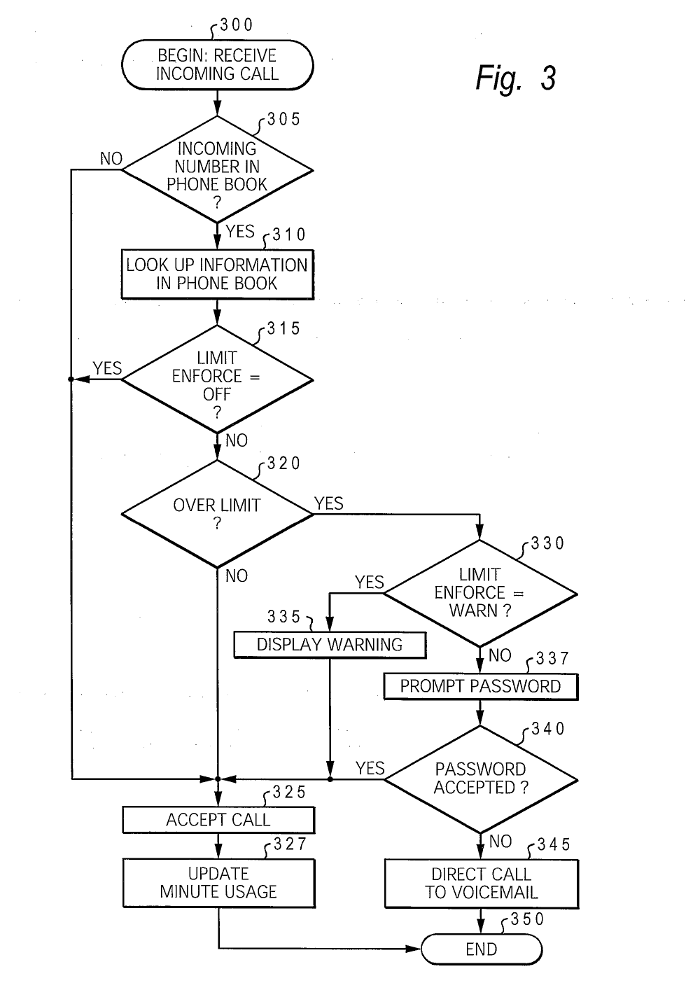

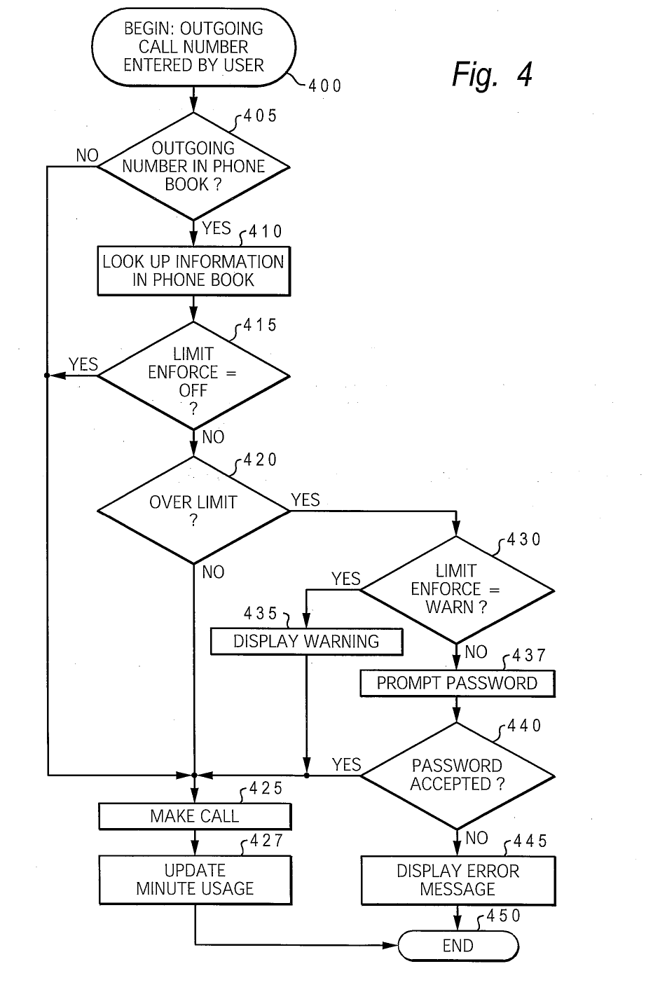

According to the illustrative embodiment, minute manager utility 120 is a software program that performs the functions of the present invention in order to enable a user of mobile phone 100 to restrict the number of minutes used during incoming and outgoing calls corresponding to particular phone numbers, as illustrated in FIGS. 3 and 4 respectively, which are described in detail below. In an alternate embodiment, minute manager utility 120 may be implemented via a software program located within a server computer (not shown) connected to a network of cellular base stations controlled by a cellular telephone service provider. In such an embodiment, minute manager utility 120 remotely monitors the minutes used by the subscriber account of mobile phone 100. The service provider selectively enabling mobile phone 100 to access the cellular network for particular incoming and outgoing calls. Similarly, minute manager utility 120 may instead be implemented via hardware components within mobile phone 100 and/or a network of cellular base stations.

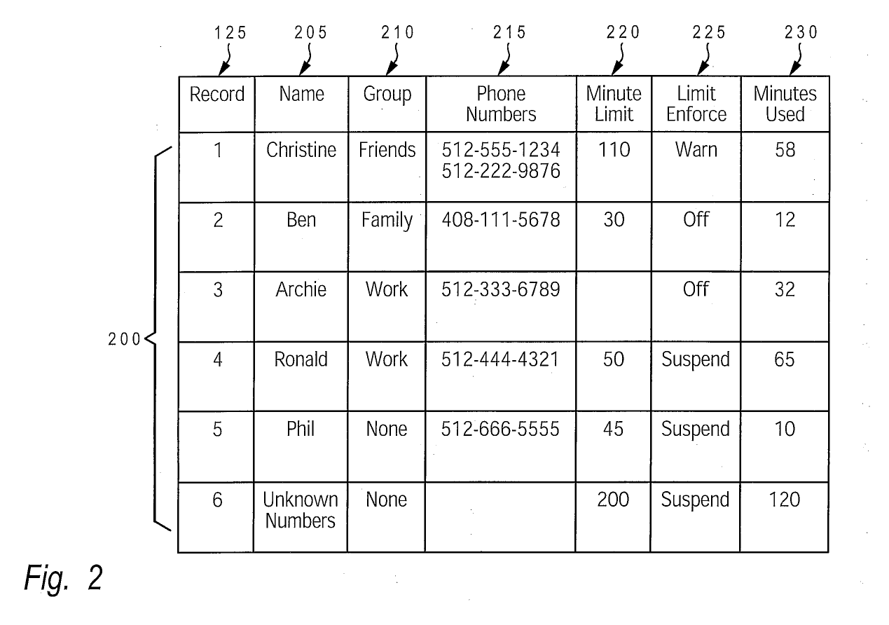

Within the descriptions of the figures, similar elements are provided similar names and reference numerals as those of the previous figure(s). Where a later figure utilizes the element in a different context or with different functionality, the element is provided a different leading numeral representative of the figure number (e.g., 1xx for FIG. 1 and 2xx for FIG. 2). The specific numerals assigned to the elements are provided solely to aid in the description and not meant to imply any limitations (structural or functional) on the invention.

In one embodiment, and as further illustrated by FIG. 2, phone book 125 is an electronic database that contains multiple records 200. Each record 200 within phone book 125 is defined by a user of mobile phone 100 and includes information corresponding to a particular person or company known to the user of mobile phone 100. The information within each record 200 of phone book 125 includes, but is not limited to, name 205 of a person or company, a categorization variable referred to herein as group 210, one or more telephone numbers 215, a user-defined minute limit 220, a user-defined control variable referred to herein as limit enforce 225; and a count of minutes used 230. According to the illustrative embodiment, minute manager utility 120 updates minutes used 230 with the duration (in minutes) of any incoming/outgoing calls that do not count as free air time. As utilized herein, free air time refers to minutes that do not count toward the monthly bill of a user of mobile phone 100 (e.g., night or weekend minutes), based on the user's subscription plan. Minute manager utility 120 automatically archives the minutes used for previous months within system memory 115 to enable a user to access historical data of the minutes used and update minute limit 220 accordingly for records 200. At the end of each month or billing period minute manager utility 120 clears all values of minutes used 230 within phone book 125 after completing the archive operation.

Minute limit 220 is an integer variable used to represent the number of minutes that a user of mobile phone 100 chooses to allot on a monthly basis to a particular record 200 within phone book 125. According to the illustrative embodiment, limit enforce 225 is a control variable that can have one of three user-defined values, “Off”, “Warn”, or “Suspend”, which are utilized by a user to control the way in which minute manager utility 120 responds when minutes used 230 exceeds minute limit 220 for one or more records. “Off” prevents minute manager utility 120 from enforcing minute limit 220. “Warn” causes minute manager utility 120 to warn a user when minute limit 220 is exceeded. “Suspend” causes minute manager utility 120 to prevent a user from making or receiving particular calls when minute limit 220 is exceeded. In an alternate embodiment, limit enforce 225 may not be defined by a user, but may instead be adjusted automatically by minute manager utility 120 according to the value of minutes used 230.

Group 210 is a categorization variable that can have values including, but not limited to, “Family”, “Friends”, or “Work”. In one embodiment, if a user does not define values for group 210, minute limit 220, and/or, minute enforce 225 for record 200, then minute manager utility 120 assigns default values of “None”, a default number of minutes (e.g., 60), and/or “Off”, respectively. A user of mobile phone 100 may thus define a maximum number of monthly minutes for a particular record 200. The user may also define a set of records 200 that contain a particular (same) value of group 210 within phone book 125. If a user of mobile phone 100 decides that multiple entries should be allocated an equal number of minutes, the user may assign the same minute limit 220 to one or more records 200. For example, a user may wish to assign numbers from a specific area code an equivalent minute limit 220.

In an alternate embodiment, minute limit 220 may represent a daily, weekly, or other amount of talk time. In another embodiment, a user of mobile phone 100 may assign an equivalent priority number 215 to a user-defined group 210 of phone numbers.

A user may also utilize a graphical user interface (GUI) and key pad 140 to select from several pre-defined options for limit enforce 225. In such an embodiment, a user may use key pad 140 to scroll through a list of available values of limit enforce 225 comprised of a range of words (e.g., off, warn, suspend), colors (e.g., green, yellow, red), symbols (e.g., blank, ˜, X), or integers (e.g., 1 through 3). If a user of mobile phone 100 does not define a value of minute limit 220 for a particular record 200, minute manager utility 120 may assign a default minute limit 220 for tracking purposes (e.g., 60 minutes).

Turning now to FIG. 3, there is illustrated a high level logical flowchart of an exemplary method of enabling a mobile phone to manage incoming calls in accordance with one embodiment of the invention. The process begins at block 300, in response to an incoming call being detected by mobile phone 100. A decision is made whether the telephone number of the incoming call corresponds to telephone number 215 of any record 200 within phone book 125, as depicted in block 305. If the telephone number of the incoming call does not match any record 200 within phone book 125, minute manager utility 120 enables the incoming call to be received by the user, as shown in block 325. As depicted in block 327, minute manager utility 120 updates minutes used 230 with the duration (in minutes) a record 200 that is used to track all unknown numbers, as illustrated by record number 6 in FIG. 2. The process then terminates at block 350 after the call is completed. In an alternate embodiment, if the telephone number of the incoming call does not match any record 200 within phone book 125, minute manager utility 120 assigns a default minute limit 220 (e.g., 60 minutes) to the incoming telephone number and the process proceeds to block 320, which is discussed below.

If the telephone number of the incoming call does match telephone number 215 of record 200 within phone book 125, minute manager utility 120 looks up the values of minute limit 220, limit enforce 225, and minutes used 230, as depicted in block 310. A determination is made at block 315 whether limit enforce 225 that corresponds to record 200 of the incoming call is equal to “Off”. If limit enforce 225 is equal to “Off”, minute manager utility 120 enables the incoming call to be received by the user, as shown in block 325. As depicted in block 327, and minute manager utility 120 updates minutes used 230 with the duration (in minutes) of the call. The process then terminates at block 350 after the call is completed.

If limit enforce 225 is not equal to “Off”, a determination is made at block 320 whether minutes used 230 is greater than or equal to minute limit 220 within record 200 that corresponds to the incoming call. If minutes used 230 is less than minute limit 220, minute manager utility 120 allows a user of mobile phone 100 to receive the incoming call, as shown in block 325. As depicted in block 327, and minute manager utility 120 updates minutes used 230 with the duration (in minutes) of the call. The process then terminates at block 350 after the call is completed. In an alternate embodiment, minute manager utility 120 tracks the minutes used by an ongoing call and updates minutes used 230 in real time to enable the user to be notified (e.g., via a beep or flash) during a call if the allotted minutes for that call are exceeded.

If minutes used 230 is greater than or equal to minute limit 220 within record 200 that corresponds to the incoming call, a determination is made whether limit enforce 225 within record 200 is equal to “Warn”, as depicted in block 330. If limit enforce 225 is equal to “Warn”, minute manager utility 120 displays a warning message using display 110 to inform a user of mobile phone 100 that minute limit 220 has been reached for the particular number/call. Minute manager utility 120 enables the incoming call to be received by the user, as shown in block 325. As depicted in block 327, and minute manager utility 120 updates minutes used 230 with the duration (in minutes) of the call. The process then terminates at block 350 after the call is completed.

If limit enforce 225 is not equal to “Warn” (i.e., if limit enforce 225 equals “Suspend”), minute manager utility 120 prompts the user for a password, as shown in block 337. A determination is made at block 340 whether a user of mobile phone 100 has entered a valid password in order to bypass the suspend function. If a user does not enter a valid password to bypass the suspend function, minute manager utility 120 displays a message on display 110 to indicate that minute limit 220 has been exceeded, directs the incoming call directly to the user's voicemail system, as shown in block 345, and notifies the user of a missed call without allowing the user to receive the incoming call. In an alternate embodiment, minute manager utility 120 utilizes a timeout function and proceeds to block 345 if a user does not enter an override password before a pre-set time elapses. If a user does enter a valid password to bypass the suspend function, minute manager utility 120 enables the incoming call to be received by the user, as shown in block 325. As depicted in block 327, and minute manager utility 120 updates minutes used 230 with the duration (in minutes) of the call. The process then terminates at block 350 after the call is completed.

With reference now to FIG. 4, there is illustrated a high level logical flowchart of an exemplary method of enabling a mobile phone to manage outgoing calls in accordance with one embodiment of the invention. The process begins at block 400 in response to an outgoing call request from a user of mobile phone 100. A decision is made whether the telephone number of the outgoing call corresponds to telephone number 215 of any record 200 within phone book 125, as depicted in block 405. If the telephone number of the outgoing call does not match any record 200 within phone book 125, minute manager utility 120 allows a user of mobile phone 100 to initiate the outgoing call, as shown in block 425. The process then terminates and minute manager utility 120 updates minutes used 230 with the duration (in minutes) of the call. In an alternate embodiment, if the telephone number of the outgoing call does not match any record 200 within phone book 125, minute manager utility 120 assigns a default minute limit 220 (e.g., 60 minutes) to the outgoing telephone number and the process proceeds to block 420, which is discussed below.

If the telephone number of the outgoing call does match telephone number 215 of record 200 within phone book 125, minute manager utility 120 looks up the values of minute limit 220 limit enforce 225, and minutes used 230, as depicted in block 410. A determination is made at block 415 whether limit enforce 225 that corresponds to record 200 of the outgoing call is equal to “Off”. If limit enforce 225 is equal to “Off”, minute manager utility 120 enables a user to make the outgoing call, as shown in block 425. As depicted in block 427, and minute manager utility 120 updates minutes used 230 with the duration (in minutes) of the call. The process then terminates at block 450 after the call is completed.

If limit enforce 225 is not equal to “Off”, a determination is made at block 420 whether minutes used 230 is greater than or equal to minute limit 220 within record 200 that corresponds to the outgoing call. If minutes used 230 is less than minute limit 220, minute manager utility 120 enables a user to make the outgoing call, as shown in block 425. As depicted in block 427, and minute manager utility 120 updates minutes used 230 with the duration (in minutes) of the call. The process then terminates at block 450 after the call is completed. In an alternate embodiment, minute manager utility 120 tracks the minutes used by an ongoing call and updates minutes used 230 in real time to enable the user to be notified (e.g., via a beep or flash) during a call if the allotted minutes for that call are exceeded.

If minutes used 230 is greater than or equal to minute limit 220 within record 200 that corresponds to the outgoing call, a determination is made whether limit enforce 225 within record 200 is equal to “Warn”, as depicted in block 430. If limit enforce 225 is equal to “Warn”, minute manager utility 120 displays a warning message using display 110 to inform a user of mobile phone 100 that minute limit 220 has been reached. Minute manager utility 120 enables a user to make the outgoing call, as shown in block 425. As depicted in block 427, and minute manager utility 120 updates minutes used 230 with the duration (in minutes) of the call. The process then terminates at block 450 after the call is completed.

If limit enforce 225 is not equal to “Warn” (i.e., if limit enforce 225 equals “Suspend”), minute manager utility 120 prompts the user for a password, as shown in block 337. A determination is made at block 440 whether a user of mobile phone 100 has entered a valid password in order to bypass the suspend function. If a user does not enter a valid password to bypass the suspend function, minute manager utility 120 displays an error message on display 110 to indicate that minute limit 220 has been exceeded and blocks the outgoing call, as shown in block 445. In an alternate embodiment, minute manager utility 120 utilizes a timeout function and proceeds to block 445 if a user does not enter an override password before a pre-set time elapses. If a user does enter a valid password to bypass the suspend function, minute manager utility 120 enables a user to make the outgoing call, as shown in block 425. As depicted in block 427, and minute manager utility 120 updates minutes used 230 with the duration (in minutes) of the call. The process then terminates at block 450 after the call is completed.

The present invention thus enables mobile phone 100 to automatically enforce user-defined restrictions on the minutes spent talking to certain phone numbers. A user of mobile phone 100 also specifies an enforcement policy that will be implemented if the allotted amount of minutes is exceeded. According to the illustrative embodiment, the available enforcement policies include displaying an informative message that the total allotted minutes have been exceeded and allowing the call to continue, or suspending the minute usage for the duration of the month or billing cycle for the phone number in question. A user of mobile phone 100 may thereby efficiently review the total minutes used per category each month and adjust minute limit 220 accordingly in order to minimize potential expenses that would otherwise be incurred if the user exceeded the minutes allocated by their mobile phone service plan.

It is understood that the use herein of specific names are for example only and not meant to imply any limitations on the invention. The invention may thus be implemented with different nomenclature/terminology and associated functionality utilized to describe the above devices/utility, etc., without limitation.

While an illustrative embodiment of the present invention has been described in the context of a fully functional computer system with installed software, those skilled in the art will appreciate that the software aspects of an illustrative embodiment of the present invention are capable of being distributed as a program product in a variety of forms, and that an illustrative embodiment of the present invention applies equally regardless of the particular type of signal bearing media used to actually carry out the distribution. Examples of signal bearing media include recordable type media such as thumb drives, floppy disks, hard drives, CD ROMs, DVDs, and transmission type media such as digital and analog communication links.

While the invention has been particularly shown and described with reference to a preferred embodiment, it will be understood by those skilled in the art that various changes in form and detail may be made therein without departing from the spirit and scope of the invention.

What is claimed is:

1. In a programmable phone device, a method comprising:
associating a minute limit characteristic to one or more entries corresponding to one or more phone numbers within a phone book of the phone device;
associating a limit enforce characteristic to said one or more entries within said phone book of the phone device;
when an incoming call is received from an incoming phone number having a pre-set minute limit characteristic, comparing a sum of minutes previously used for calls with the incoming phone number to the pre-set minute limit characteristic associated with the incoming phone number;
when the sum of minutes previously used for calls with said incoming phone number is at least as high as the pre-set minute limit characteristic associated with said incoming phone number and the limit enforce characteristic associated with said incoming phone number is a warning value, displaying a warning message to a user of said phone device and enabling the user to receive said incoming call; and
when the sum of minutes previously used for calls with said incoming phone number is at least as high as the pre-set minute limit characteristic associated with said incoming phone number and the limit enforce characteristic associated with said incoming phone number is a suspend value, automatically forwarding said incoming call to the voicemail of the phone device.

2. The method of claim 1, further comprising:
when an outgoing call is made to an outgoing phone number having a pre-set minute limit characteristic, comparing a sum of minutes previously used for calls with the outgoing phone number to the pre-set minute limit characteristic associated with the outgoing phone number;
when the sum of minutes previously used for calls with said outgoing phone number is at least as high as the pre-set minute limit characteristic associated with said outgoing phone number and the limit enforce characteristic associated with said outgoing phone number is a warning value, displaying a warning message to a user of said phone device and enabling the user to make said outgoing call; and
when the sum of minutes previously used for calls with said outgoing phone number is at least as high as the pre-set minute limit characteristic associated with said outgoing phone number and the limit enforce characteristic associated with said outgoing phone number is a suspend value, automatically blocking said outgoing call and displaying a message to a user of said phone device indicating said outgoing call has been blocked because said pre-set minute limit has been exceeded.

3. The method of claim 1, wherein said associating further comprises:
assigning an integer indicative of the minute limit characteristic of the one or more entries within the phone book; and
storing the integer within a record corresponding to the respective entry among the one or more entries within the phone book.

4. The method of claim 1, wherein:
said comparing further comprises:
on receipt of said incoming call, checking the phone book for an entry of the incoming phone number and an associated minute limit characteristic;
on receipt of a request to make said outgoing call, checking the phone book for an entry of the outgoing phone number and an associated minute limit characteristic;
assigning a default minute limit characteristic to the phone number of said incoming call when one or more trigger conditions results from said checking; and
assigning a default minute limit characteristic to the phone number of said outgoing call when one or more trigger conditions results from said checking, said trigger conditions including: (a) said checking results in a first determination that said incoming or outgoing phone number is not an entry within the phone book; and (b) said checking results in a second determination that said incoming or outgoing phone number does not have an associated minute limit characteristic.

5. The method of claim 1, wherein said automatically blocking further comprises:
preventing said outgoing call from being initiated and displaying said message to the user when said default minute limit characteristic of said outgoing call has a lower value than said pre-set minute limit characteristic of the user's mobile phone service plan;
prompting the user for an override password; and
enabling said outgoing call to be initiated if said override password is correctly entered 7 within a pre-established time period.

6. The method of claim 1, further comprising:
generating and displaying a user interface that enables selection by a user of the minute limit characteristic and the limit enforce characteristic to assign to the one or more entries of the phone book; and
receiving an entry of the minute limit characteristic and an entry of the limit enforce characteristic via a user input, wherein the step of generating and displaying the user interface comprises providing within the user interface one or more of:
a minute limit scale representing the range of possible minute limit characteristics that may selectively be assigned to selected entries within the phone book, wherein said minute limit scale includes integers ranging from 0 to a maximum number of minutes allowed by the user's mobile phone service plan; and
a limit enforce scale representing the range of possible limit enforce characteristics that may selectively be assigned to selected entries within the phone book, wherein said limit enforce scale includes limit enforce characteristics “Off”, “Warn”, and “Suspend”.

7. A programmable phone device comprising:
a processor;
a memory having stored therein a phone book that contains a plurality of records corresponding to telephone numbers; and
a minute manager utility within said system memory that provides means for enabling an integer indicating a minute limit characteristic and a string indicating a limit enforce characteristic to be assigned to one or more of the plurality of records within said phone book;
wherein said minute limit characteristic and said limit enforce characteristic enable the utility to selectively allow and block incoming and outgoing call functions of said phone device based on the current sum of minutes used assigned to a record corresponding to a phone number of an incoming or outgoing call having a pre-set minute limit.

8. The phone device of claim 7, wherein said minute manager utility further comprises:
means for associating a minute limit characteristic to one or more entries within a phone book of the phone device;
means for associating a limit enforce characteristic to said one or more entries within said phone book of the phone device;
means for comparing a sum of minutes previously used for calls with the incoming phone number to the pre-set minute limit characteristic associated with the incoming phone number when an incoming call is received from an incoming phone number having a pre-set minute limit characteristic;
means for displaying a warning message to a user of said phone device and enabling the user to receive said incoming call when the sum of minutes previously used for calls with said incoming phone number is at least as high as the pre-set minute limit characteristic associated with said incoming phone number and the limit enforce characteristic associated with said incoming phone number is a warning value; and
means for automatically forwarding said incoming call to the voicemail of the phone device when the sum of minutes previously used for calls with said incoming phone number is at least as high as the pre-set minute limit characteristic associated with said incoming phone number and the limit enforce characteristic associated with said incoming phone number is a suspend value.

9. The phone device of claim 7, wherein said minute manager utility further comprises:
means for comparing a sum of minutes previously used for calls with the outgoing phone number to the pre-set minute limit characteristic associated with the outgoing phone number when an outgoing call is made to an outgoing phone number having a pre-set minute limit characteristic;
means for displaying a warning message to a user of said phone device and enabling the user to make said outgoing call when the sum of minutes previously used for calls with said outgoing phone number is at least as high as the pre-set minute limit characteristic associated with said outgoing phone number and the limit enforce characteristic associated with said outgoing phone number is a warning value; and
means for automatically blocking said outgoing call and displaying an error message to a user of said phone device when the sum of minutes previously used for calls with said outgoing phone number is at least as high as the pre-set minute limit characteristic associated with said outgoing phone number and the limit enforce characteristic associated with said outgoing phone number is a suspend value.

10. The phone device of claim 7, wherein said means for associating further comprises:
means for assigning an integer variable indicative of the minute limit characteristic of the one or more entries within a phone book; and
means for storing the integer variable within a record corresponding to the respective entry among the one or more entries within the phone book.

11. The phone device of claim 7, wherein:
said means for comparing further comprises:
on receipt of said incoming call, means for checking the phone book for an entry of the incoming phone number and an associated minute limit characteristic;
on receipt of a request to make said outgoing call, means for checking the phone book for an entry of the outgoing phone number and an associated minute limit characteristic; and
means for assigning a default minute limit characteristic to the phone number of said incoming or outgoing call when one or more trigger conditions results from said checking, said trigger conditions including: (a) said checking results in a first determination that said incoming or outgoing phone number is not an entry within the phone book; and (b) said checking results in a second determination that said incoming or outgoing phone number does not have an associated minute limit characteristic.

12. The phone device of claim 7, wherein said means for automatically blocking further comprises:
means for preventing said outgoing call from being initiated and displaying said message to the user when said default minute limit characteristic of said outgoing call has a lower value than said pre-set minute limit characteristic of the user's mobile phone service plan;
means for prompting the user for an override password; and
means for enabling said outgoing call to be initiated if said override password is correctly entered within a pre-established time period.

13. The phone device of claim 7, further comprising:
means for generating and displaying a user interface that enables selection by a user of the minute limit characteristic and the limit enforce characteristic to assign to the one or more entries of the phone book; and
means for receiving an entry of the minute limit characteristic and an entry of the limit enforce characteristic via a user input, wherein the step of generating and displaying the user interface comprises means for providing within the user interface one or more of:
a minute limit scale representing the range of possible minute limit characteristics that may selectively be assigned to selected entries within the phone book, wherein said minute limit scale includes integers ranging from 0 to a maximum number of minutes allowed by the user's mobile phone service plan; and
a limit enforce scale representing the range of possible limit enforce characteristics that may selectively be assigned to selected entries within the phone book, wherein said limit enforce scale includes limit enforce characteristics “Off”, “Warn”, and “Suspend”.

14. A computer program product comprising:
a computer readable medium; and program code on said computer readable medium that that when executed provides the functions of:
associating a minute limit characteristic to one or more entries within a phone book of the phone device;
associating a limit enforce characteristic to said one or more entries within said phone book of the phone device;
when an incoming call is received from an incoming phone number having a pre-set minute limit characteristic, comparing a sum of minutes previously used for calls with the incoming phone number to the pre-set minute limit characteristic associated with the incoming phone number;
when the sum of minutes previously used for calls with said incoming phone number is at least as high as the pre-set minute limit characteristic associated with said incoming phone number and the limit enforce characteristic associated with said incoming phone number is a warning value, displaying a warning message to a user of said phone device and enabling the user to receive said incoming call; and
when the sum of minutes previously used for calls with said incoming phone number is at least as high as the pre-set minute limit characteristic associated with said incoming phone number and the limit enforce characteristic associated with said incoming phone number is a suspend value, automatically forwarding said incoming call to the voicemail of the phone device.

15. The computer program product of claim 14, further comprising code for:
when an outgoing call is made to an outgoing phone number having a pre-set minute limit characteristic, comparing a sum of minutes previously used for calls with the outgoing phone number to the pre-set minute limit characteristic associated with the outgoing phone number;
when the sum of minutes previously used for calls with said outgoing phone number is at least as high as the pre-set minute limit characteristic associated with said outgoing phone number and the limit enforce characteristic associated with said outgoing phone number is a warning value, displaying a warning message to a user of said phone device and enabling the user to make said outgoing call; and
when the sum of minutes previously used for calls with said outgoing phone number is at least as high as the pre-set minute limit characteristic associated with said outgoing phone number and the limit enforce characteristic associated with said outgoing phone number is a suspend value, automatically blocking said outgoing call and displaying an error message to a user of said phone device.

16. The computer program product of claim 14, wherein said program code for completing said associating further comprises code for:
assigning an integer variable indicative of the minute limit characteristic of the one or more entries within a phone book; and
storing the integer variable within a record corresponding to the respective entry among the one or more entries within the phone book.

17. The computer program product of claim 14, wherein:
said program code for comparing further comprises code for:
on receipt of said incoming call, checking the phone book for an entry of the incoming phone number and an associated minute limit characteristic;
on receipt of a request to make said outgoing call, checking the phone book for an entry of the outgoing phone number and an associated minute limit characteristic; and
assigning a default minute limit characteristic to the phone number of said incoming or outgoing call when one or more trigger conditions results from said checking, said trigger conditions including: (a) said checking results in a first determination that said incoming or outgoing phone number is not an entry within the phone book; and (b) said checking results in a second determination that said incoming or outgoing phone number does not have an associated minute limit characteristic.

18. The computer program product of claim 14, wherein said code for automatically blocking further comprises:
code for preventing said outgoing call from being initiated and displaying said message to the user when said default minute limit characteristic of said outgoing call has a lower value than said pre-set minute limit characteristic of the user's mobile phone service plan;
code for prompting the user for an override password; and
code for enabling said outgoing call to be initiated if said override password is correctly entered within a pre-established time period.

19. The computer program product of claim 14, further comprising code for:
generating and displaying a user interface that enables selection by a user of the minute limit characteristic and the limit enforce characteristic to assign to the one or more entries of the phone book; and
receiving an entry of the minute limit characteristic and an entry of the limit enforce characteristic via a user input, wherein the code for generating and displaying the user interface comprises code for providing within the user interface one or more of:
a minute limit scale representing the range of possible minute limit characteristics that may selectively be assigned to selected entries within the phone book, wherein said minute limit scale includes integers ranging from 0 to a maximum number of minutes allowed by the user's mobile phone service plan; and
a limit enforce scale representing the range of possible limit enforce characteristics that may selectively be assigned to selected entries within the phone book, wherein said limit enforce scale includes limit enforce characteristics “Off”, “Warn”, and “Suspend”.
